(19) United States
(12) Patent Application Publication
(10) Pub. No.: US 2025/0013133 A1
(43) Pub. Date: Jan. 9, 2025

(54) BLINK ANIMATION PROJECTOR AND SYSTEM

(71) Applicant: MINDSCOPE PRODUCTS, Glendale, CA (US)

(72) Inventors: JOHN SINISI, WARMINSTER, PA (US); JESSE SINISI, WARMINSTER, PA (US)

(21) Appl. No.: 18/210,618

(22) Filed: Jun. 15, 2023

(51) Int. Cl. G03B 21/00; G03B 21/20; G03B 31/04

(52) U.S. Cl. CPC G03B 21/001; G03B 21/2033; G03B 21/206; G03B 21/2066; G03B 31/04

(57) ABSTRACT

The present invention is generally directed to a projector system and method that utilizes a number of light sources with associated films or slides, wherein each film or slide has an image thereon, and by selectively lighting the light sources in certain sequences, an illusion of animation may be achieved. Projector systems may include arrays of light emitting diodes (LEDs), reflectors, condensers, lens groups comprising one or more lenses, and/or aperture or light box elements to reduce stray light. Arrays may be configured in a non-planar arrangement to align projection of images on a flat, curved, or irregular substrate. Sounds corresponding to animation images may be played via an attached audio output device.

### FIELD OF THE INVENTION

In general, the present invention is directed to a device for projecting an animated or moving image. More specifically, a projector in accordance with some embodiments of the present invention may utilize a plurality of light sources which may emit light through a slide or film with an image thereon in a particular sequence.

### BACKGROUND

Various household items, decorations, and/or toys may incorporate the use of a projector to project various images, animations, and/or video data. Such projectors may project outside of an item—such as on a wall or exterior surface, or may project on a surface or portion of the household item, decoration, and/or toy itself. Small projectors have been developed that utilize a light source shining through a slide to project a single fixed image. Such projectors have been developed that project a series of images, forming a slide show or generating an animated image. However, such projectors have significant drawbacks such as size, weight, power requirements, ability to produce a sharp focused image, etc. In addition, existing projection methods offer far less resolution or fewer and simpler animation patterns using only cut outs and shadows. Other existing projectors use a simple lens system that does not accurately blend segments of an image or eliminate stray and control the light path and optical path accurately. Therefore, there is a need for a low-cost, easy to manufacture projection device that can be utilized in toys, decorative items, and other devices, often with a limit throw distance.

### SUMMARY OF THE INVENTION

In accordance with some embodiments of the present invention, aspects may include a projector for producing animation by flashing or blinking one or more light sources in a sequence, each light source associated with a specific image, the projector comprising: a light array, comprising two or more light emitting diodes (LEDs), configured in a geometric pattern; a reflector array, comprising a reflector cone for each LED, each reflector cone comprising an orifice or opening for receiving light from an LED, a reflective surface, and an output for shining the light from the LED, the reflector array configured in the geometric pattern to align the orifice or opening with each LED in the light array; and a film array, comprising a film portion aligned with each reflector cone in the reflector array, each film portion having an image printed, pasted, or saved thereon.

In accordance with some embodiments of the present invention, aspects may include a projector for producing animation by flashing or blinking one or more light sources in a sequence, each light source associated with a specific image, the projector comprising: a light array, comprising two or more light emitting diodes (LEDs), configured in a geometric pattern; a reflector and condenser array, comprising a reflector cone for each LED, each reflector cone comprising an orifice or opening for receiving light from an LED, a reflective surface, and an output for shining the light from the LED, the reflector array configured in the geometric pattern to align the orifice or opening with each LED in the light array; a film array, comprising a film portion aligned with each reflector cone in the reflector array, each film portion having an image printed, pasted, or saved thereon; and two or more lenses disposed proximate to the film array, the two or more lenses configured to reduce false aberrations; wherein the light array, reflector array, film array, and lenses are configured in a curved parabolic orientation.

These and other aspects will become apparent from the following description of the invention taken in conjunction with the following drawings, although variations and modifications may be affected without departing from the scope of the novel concepts of the invention.

### DESCRIPTION OF THE FIGURES

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary projector, in accordance with some embodiments of the present invention.

FIGS. 2A-2B illustrate an exemplary animation, in accordance with some embodiments of the present invention.

FIG. 3 illustrates exemplary light sources for a projector, in accordance with some embodiments of the present invention.

FIG. 4 illustrates an exemplary projector, in accordance with some embodiments of the present invention.

FIG. 5 illustrates an exemplary controller, in accordance with some embodiments of the present invention.

FIG. 6 illustrates an exemplary device with a projector, in accordance with some embodiments of the present invention.

FIG. 7 illustrates an exemplary device with a projector, in accordance with some embodiments of the present invention.

FIG. 8 illustrates exemplary projector components, in accordance with some embodiments of the present invention.

FIG. 9 illustrates exemplary projector components, in accordance with some embodiments of the present invention.

FIGS. 10A and 10B illustrate an exemplary item or toy with an integral projector, in accordance with some embodiments of the present invention.

FIG. 11 illustrates an exemplary item or toy with an integral projector, in accordance with some embodiments of the present invention.

FIGS. 12A and 12B illustrate an exemplary item or toy with variable width cutouts aligned with light sources, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

In general, the present invention provides a projection system comprising programing software and digital triggering system connected to an array of two or more light sources focused at the same general projection area with a image on film or a related transparent substrate positioned proximate to the light sources such that the images visually align with each other both in parts and sequentially. As each light is then flashed on and off sequentially an illusion of animation—such as but not limited to a moving mouth, eyes and nose, etc. can be achieved within a single face. For standard animation of speech there may be a number of phoneme shapes for specific mouth shapes to form all the specific sounds of speech (for example, twelve (12)). Based on this an ideal array of lights for mouth shapes may be twelve (12) lights with twelve (12) phoneme shapes as the image art.

In accordance with some embodiments of the present invention, a projection device may not include moving parts to achieve fully animated speech, there reducing complexity of manufacture and operation. Additional lights may be included in an array to achieve additional features such as specific expressions or details like eye movements and nose movements to match or enhance the speech.

Note that the system is not limited to facial animations but may be used to play short sequences and or repeat animations. In some cases, it may be desirable to use hundreds of lights to project an entire sequence of animation for a very low cost of operation. In other applications it may be desirable to animate a full background scene then change only small sections or areas of the scene with blended light sequencing and frame matching.

When used as a back light projection on the inside surface of a molded shape, the system may animate figures and/or faces in a very tight space.

The light source may be any light source as known in the art, such as light emitting diodes (LEDs), each individually addressable and controlled by a microcontroller capable of using direct preprogrammed or a generated pattern from the programing to blink the LED's in a specific sequence or patterns. When the blinking lights are then flashed in time with the sounds for speech indicating the correct phoneme shape for the correct sound, fully animated speech may then be achieved by blinking the lights on and off at specific times.

When combined with digital software and controls, devices, systems, and methods in accordance with the present invention may be able to manipulate the light and frame rates in a number of ways to create blends and effects. By including an additional aperture and condenser, stray light that may impact image clarity and sharpness may be eliminated. A parabolic multi-lens array may further provide superior image blends and focal range for special effects and clarity.

In addition to slides or films, it is also contemplated that a printed or molded image over a transparent substrate such as directly on to a lens, that is either molded or an emulsion, may be used. This may allow for more detail and color options than a simple shadow box and may be less costly than a separate film. For example, an image may be printed directly on the back of lens to eliminate the need for a separate strip of film. A lens array may be molded and arranged on a parabolic curve to allow for a broader range of infinite focal length and more accurately aligned images with less distortion. Therefore, various segments of an image may be combined with each other to make a single image. In this manner, one section of an image may be animated without requiring changes to other portions of the image.

Systems in accordance with some embodiments of the present invention may be used with or without a lens for more precise focal and alignment options. In accordance with some embodiments, an image may be placed on a transparent substrate, and no additional lens may be required. Lens array design may be contoured depending on the shape of the desired contoured screen. For example, in the application of a projected face, features like eyes nose and mouth may be projected to specific areas with specific shapes representing these areas in three-dimensional space for a more realistic three-dimensional projection of a face or an entire human head rather than a simple two-dimension or flatter screen.

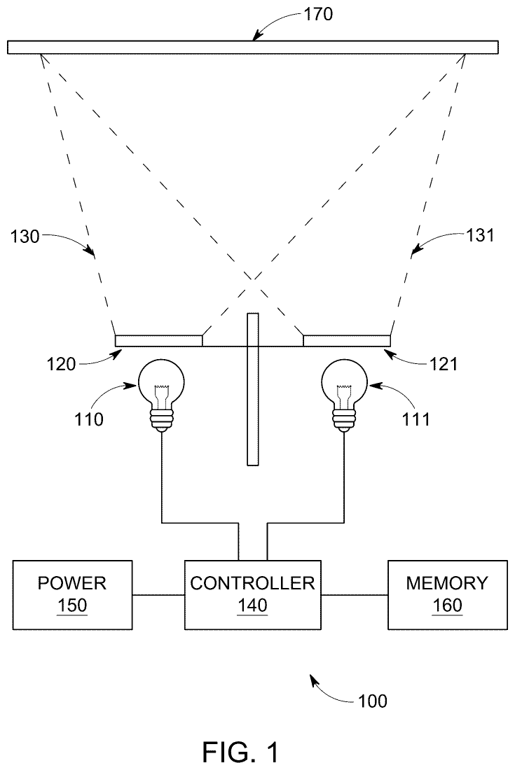

With reference to FIG. 1, a projection system 100 in accordance with some embodiments of the present invention will now be discussed. Projection system 100 may comprise two or more light sources 110, 111, two or more films or slides 120, 121, a controller or processor 140, power source 150, and memory 160. When one or more of light sources 110, 111 are lit, it may shine light through the one or more films or slides 120, 121, which may project an image on the film or slide 120, 121 through a projection path 130, 131, and onto a substrate 170.

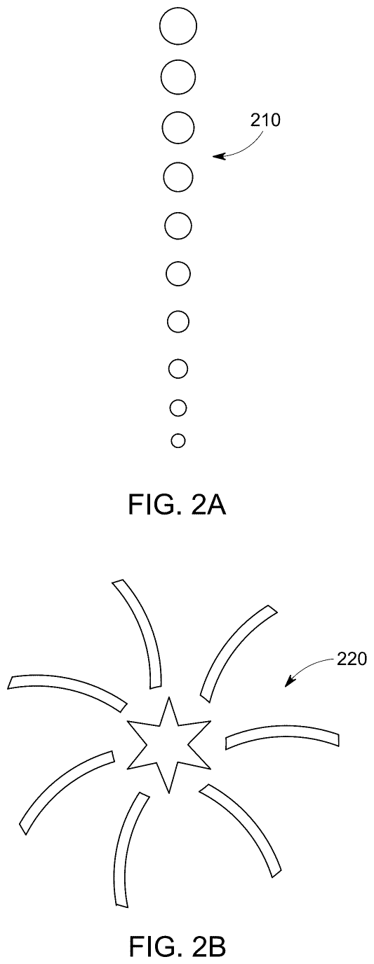

Light sources 110, 111 may be any light source, though it is contemplated that light emitting diodes (LEDs) may be used for reliability, low-power requirements, and cost advantages. By projecting different images at different times, an illusion of animation may be achieved. For example, with reference to FIGS. 2A and 2B, a first frame may illustrate a firework path 210, while a second frame may illustrate a firework explosion 220. By flashing the light sources in sequence, a basic animation effect may be achieved.

As animations become more complex, additional light sources and films or slides may be needed or desirable. With reference to FIG. 3, a housing 300 may comprise multiple light sources 310, 311, 312, 313, each light source with an associated film or slide 320, 321, 322, 333. The light sources and/or films or slides may be separated from each other to prevent light from one light source inadvertently illuminating a slide or film associated with a different light source.

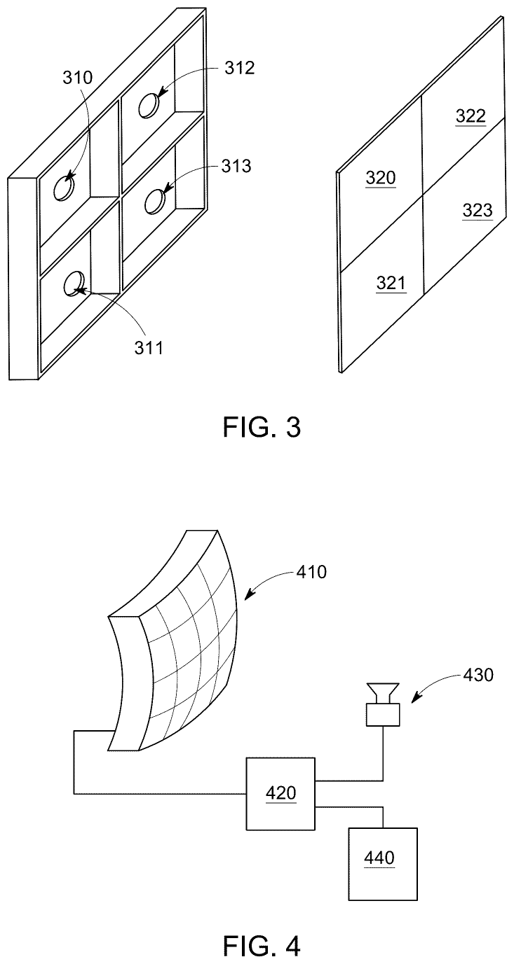

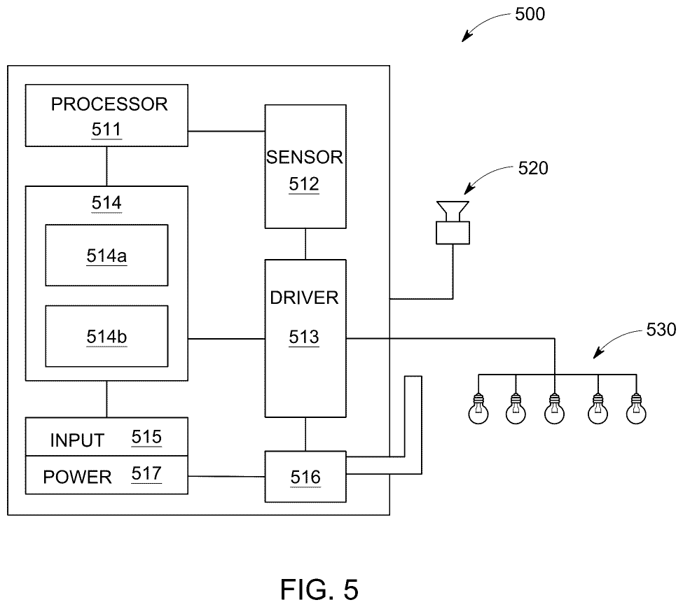

With reference to FIG. 4, an exemplary system 400 may be seen, comprising a projector 410, processor 420, speaker 430, and power source 440. Notably, projector 410 illustrates a multiple light source or lens array, that may be configured in a parabolic arrangement. A parabolic arrangement—other contoured arrangement—may be utilized to project images in an overlapping and focused manner on a surface that may not be flat.

With reference to FIG. 5, an exemplary controller or processor 500 in accordance with some embodiments of the invention will now be discussed. Controller 500 may comprise one or more housings 510, in which various components may be disposed. Components may communicate with each other as needed to achieve functionality of the controller. Components may comprise a processor 511, one or more sensors 512, one or more drivers 513 for video or audio, a memory 514 that may comprise video 514B and/or audio 514A files, an input device 515, and/or a wireless communication module 516. Controller 500 may be connected to an audio output device, such as speaker 520, and to a projector 530 for video/image output.

Wireless communication module may communicate—for example via Wi-Fi, Bluetooth, or other near-field communication (NFC) protocols with a computing device such as a smartphone or other device, and/or from the Internet. In accordance with some embodiments, the present invention may utilize wireless micro-gateways, cellular communications, wi-fi communications, Bluetooth communications, and/or ethernet communications. Cellular communications may ride on 4G LTE, 2G, and it is contemplated that such communications may ride on 5G networks, and/or LTE CAT-M1 (category M1, low-power wide area cellular technology) and/or CAT-NB (narrowband) cellular.

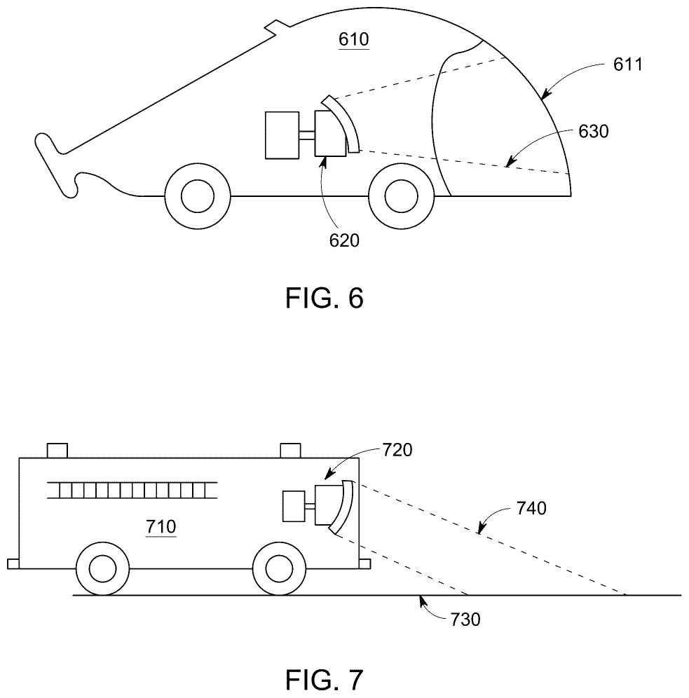

With reference to FIG. 6, it is to be understood that projectors in accordance with some embodiments of the present invention may be used to project images on to a substrate associated with the device itself—as shown in FIG. 6—or outside of the device—as shown in FIG. 7. FIG. 6 illustrates an exemplary toy 610 with a substrate 611. Toy 610 includes an internally located projector system 620, which may project (projection throw illustrated at 630) onto substrate 611. In this manner, a face or other features or elements may be projected and animated on the toy 610.

FIG. 7 illustrates an alternative toy 710, again with an internal projector system 720. However, in FIG. 7 the projector system 720 projects outside of the toy (projection throw illustrated at 740) onto an external substrate 730, illustrated as a floor or bottom surface.

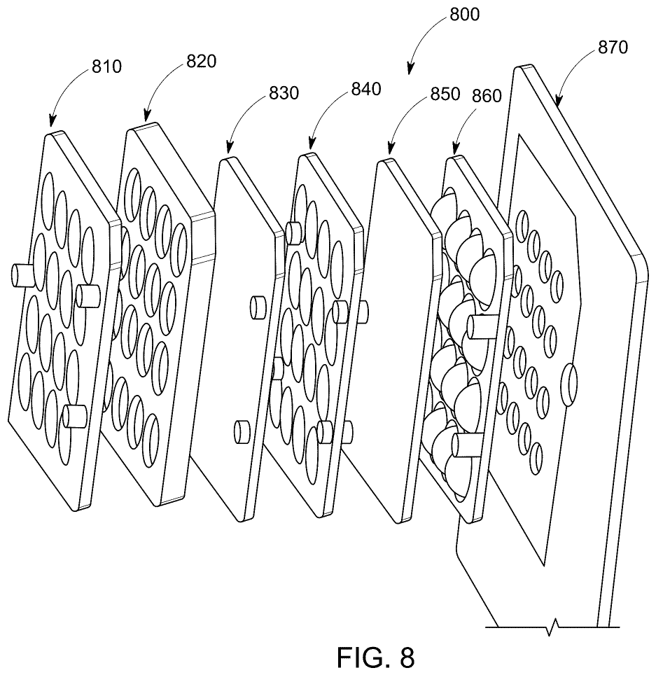

With reference to FIG. 8, details of a projector system 800 in accordance with some embodiments of the present invention will now be discussed. Projector system 800 comprises one or more light sources 870 positioned in a grid format. Aligned with the light sources, a condenser 860 may be used to reduce stray light and increase brightness of the light source. An optical film 850 may be used, upon which image content may be printed, pasted, or otherwise stored or placed thereon. An aperture component 820 may be used to additionally reduce stray light. One or more lenses 810, 830, 840 may be used to improve clarity. It has been determined through testing and experimentation that a single light transmitting lens may have undesirable aberrations. Additional lenses may produce a clearer image with less aberrations.

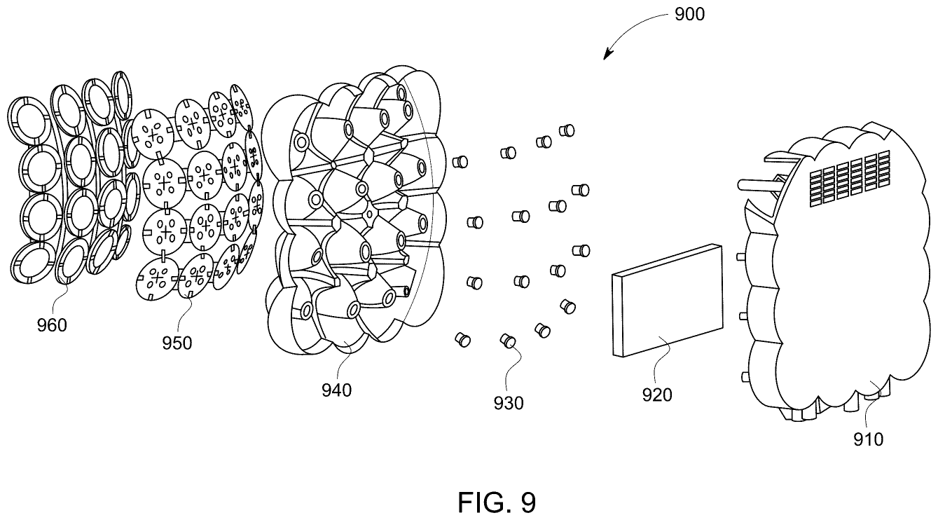

With reference to FIG. 9, an exploded view of an exemplary projector 900 in accordance with some embodiments of the present invention will now be discussed. Projection 900 may comprise a housing 910, with a printed circuit board (PCB) controller 920, which may be connected to an LED array 930 comprising one or more LEDs. A reflector array 940 may be disposed proximate to the LED array 930 in order to direct and reflect light produced by the LEDs. A film 950 comprising an image associated with each of the LEDs, aligned with the reflection array 940 may be disposed proximate to the reflection array 940. A frame 960 may be utilized to hold the film 950 in place over the reflector array 940.

Note that the components may be disposed in a parabolic, curved, or other non-planar disposition. By positioning the outer light output sources at angles, the light paths may each be projected towards the same area on the projected surface medium. The alignment positioning directly correlates to the intended distance of the medium from the projection system. The medium may be a screen or wall, or any number of surfaces.

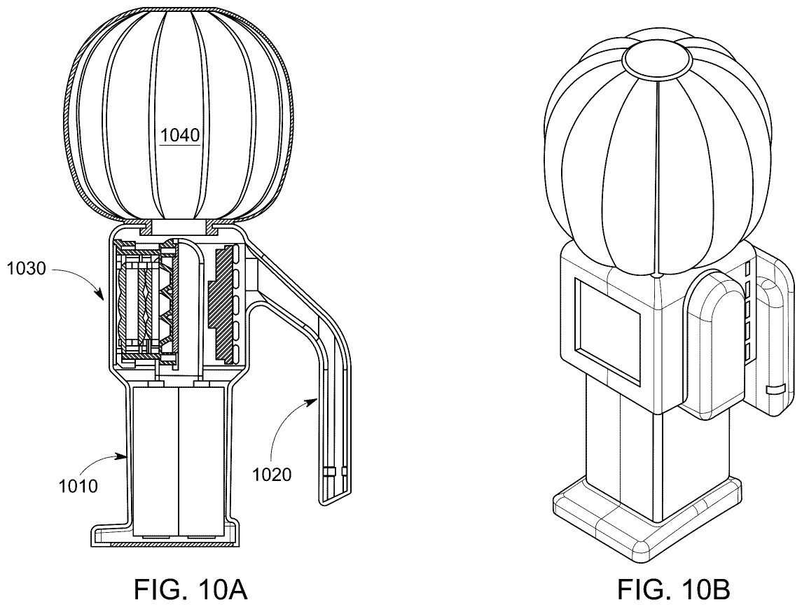

FIGS. 10A and 10B illustrate a view of an application of the present invention, showing an item with a base 1010, a handle 1020, an internal projector 1030, and a decorative “head” 1040. In this manner, animations may be projected out of the item onto an external substrate.

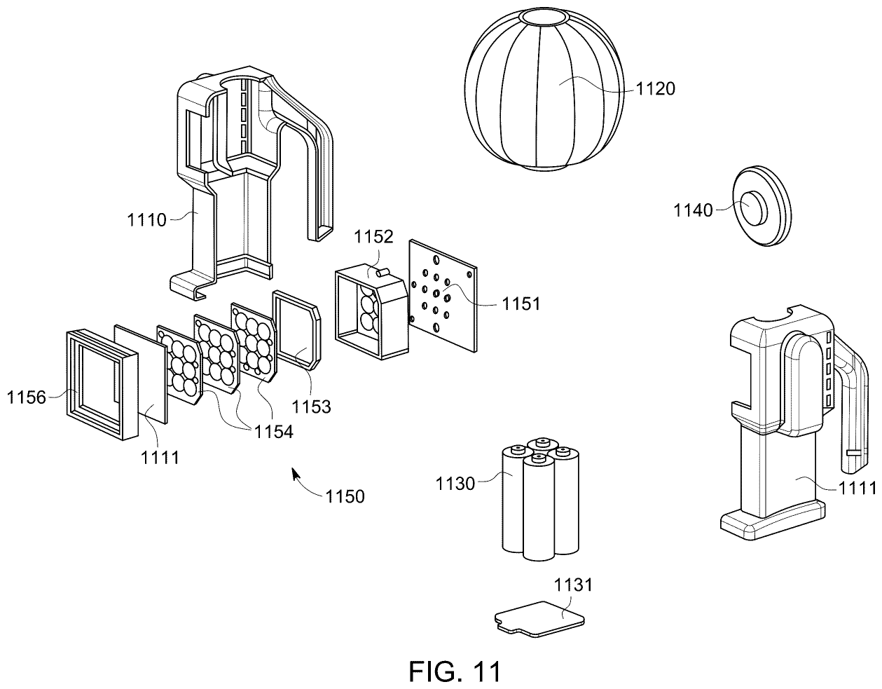

FIG. 11 illustrates an exploded view of the item shown in FIGS. 10A and 10B. The item may comprise components including: left housing and right housing 1110, 1111; a character head 1120; a power source such as batteries 1130, held in the item by a battery door 1131; a speaker 1140; and a projector system 1150. Projector system 1150 may comprise a combination PCB/LED light array 1151, a light box 1152, film 1153, optional lens arrays 1154, optional diffuser 1155, and a frame 1156.

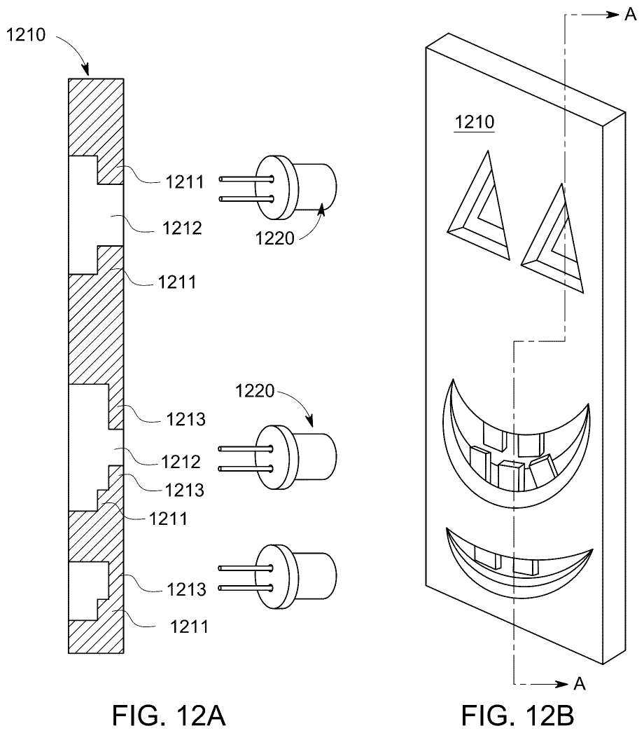

With reference to FIGS. 12A and 12B, an item 1210 in accordance with some embodiments of the present invention will now be discussed. In general, item may include a plate 1210 in lieu of the films discussed above. This plate 1210 may comprise various cutouts 1211, 1212, 1213 for shining light from a light source 1220 therethrough. The cutouts may have different thicknesses, as shown in cross-section view FIG. 12A. For example, cutout 1212 may be entirely through the plate 1210, while cutout 1211 may be approximately half-thickness. Cutout 1213 may be approximately a quarter thickness of plate 1210. Projecting the light from light sources 1220 through the cutouts may provide gradations, causing a more grey-scale projection, rather than merely “on” or “off.” In this manner, a single light source can be used to project various shades of color, images, etc. Coupled with the use of multiple lights as discussed above, even greater degrees of projected motion or animation can be achieved by utilizing the various shades of light.

Various components have been discussed above. Details regarding such components are listed below. However, please note that this discussion is for background purposes—items as known in the art are contemplated, even if not explicitly set forth below.

Software. In order to determine efficient and proper animation for speech, specific software may be used that sequences files from pre-recorded animations using a pretrained linguistics model to recognize phonemes and place them at the proper time in the sequence file. Images may be considered segments of a face, which may then be collated together with other images to make a single face. Multiple variations to simulate speech and expressions with specific LED sequencing may be applied. This may allow for animations with multiple variations using more than one LED at a time rather than just a few sequenced frames based on the number of lights sources and frames.

In addition, software has been developed that may capture an individual's speech and translate it to phonemes and associated LED sequencing in real or near real-time. This may allows for an individual to speak into a microphone or other input device and then have the a projected face animated to match the speaker's speech into an animated sequence that is projected on a screen.

Processor. A processor may be included that may determine and/or dictate the sequence upon which the light source outputs are enabled to display the output projected frames. To achieve an animation, only of one light source outputs may be enabled at a time. To achieve an animation sequence, the microprocessor may enable the sequencing of animations in order. The microprocessor may run on a continuous loop in sequence to show, for example, a character running, or oscillate in a back and forth to show, for example, a character jumping up and down. In accordance with some embodiments, sound may be linked to the animation. The microprocessor may be connected to sound chip and output speaker. The sound chip may be, for example, a commodity embedded digital audio sample playback system. Each slide image projected by its light source may correspond to a vocal sound or phoneme. When a phrase is activated by the user, the series of phonemes that are produced through speech are timed to be heard at the same time that the corresponding slide is seen. The result may be a simulation of a talking face that makes vocal gestures timed with speech sounds. One possible implementation for this embodiment would be for the animation of facial features within, for example, a toy action figure.

Storage Device. A storage device, such as an SD card and reader, can be included within the enclosure to store the animated image data for the animated image to be projected. The storage device may store image data and/or animated image data in a wide variety of ways. In some embodiments, the storage device may be a magnetic hard drive, optical storage device, or flash memory device. The storage device may store data directly, or via a storage medium that is removable from the storage device. In some exemplary embodiments, the storage device may be a universal serial bus (USB) socket that receives a USB drive, a secure digital (SD) card reader, a micro-SD card reader, and/or the like. In the examples set forth above, the storage medium may be a USB drive, an SD card, or a micro-SD card.

Communication Module. Additionally or alternatively, a communications device can be included that receives the animated image data from a source, for example via wired or wireless communication. The animated image data can be streamed as it is transmitted, or stored on a local storage device in the enclosure and then played after being stored. An internal storage device and/or communications device may store and/or receive audio and/or images, such as static and/or animated images. Animated images can be received from a computing device such as a smartphone or other device, and/or from the Internet. In at least one embodiment, a user can purchase and/or download animated images via a computer or smartphone, for playback on the device.

Updates and changes to the animated image can be made by, for example, replacing the storage device (such as the SD card) or by transmitting new animated images directly to the device (such as via a smartphone application and via direct connections to the internet over Wi-Fi). Such a system can be used to display any type of animation, such as for example a moving image of a talking and singing face. The animation can be preset, interactive (so that it responds to environmental stimuli), or a combination of the two.

Speaker. The speaker may be of any known type that produces the desired type of audio. Many different types of audio may be produced, such as music, dialogue (for example, spoken by a face that appears on the exterior surface of the enclosure), sound effects, and/or the like. Sound produced by the speaker may pass through the exterior wall and/or through the vents, to be heard by the user. In some embodiments, the interior surface may function in concert with the exterior wall to produce sound in a manner similar to that of a ported speaker, such as subwoofer, with an interior chamber in which sound resonates prior to being released through the port(s).

Power Source. A power supply (such as a battery) can be included within the device; alternatively, a power cord can be provided that allows the device to be powered from an external source.

Sensors. In at least one embodiment, the system can also include a sensor that detects motion, heat, and/or other conditions to enable the system to react to external events (such as a person walking by) and cause the animated image to change accordingly. In at least one embodiment, an artificial intelligence component can be included, to allow the animated image to speak or interact in real-time, with content that adapts and reacts to environmental stimuli. In yet another embodiment, the animated image can be controlled in real-time by a user.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

What is claimed is:

1. A projector for producing animation by flashing or blinking one or more light sources in a sequence, each light source associated with a specific image, the projector comprising:
a light array, comprising two or more light emitting diodes (LEDs), configured in a geometric pattern;
a reflector array, comprising a reflector cone for each LED, each reflector cone comprising an orifice or opening for receiving light from an LED, a reflective surface, and an output for shining the light from the LED, the reflector array configured in the geometric pattern to align the orifice or opening with each LED in the light array; and
a film array, comprising a film portion aligned with each reflector cone in the reflector array, each film portion having an image printed, pasted, or saved thereon.

2. The projector of claim 1, wherein the light array, reflector array, and film array are configured in a curved parabolic orientation.

3. The projector of claim 1, further comprising a frame element, the frame element holding the film array in contact with the reflector array.

4. The projector of claim 1, further comprising a speaker.

5. The projector of claim 1, further comprising an aperture array, the aperture array disposed adjacent to the film array, configured to reduce stray light.

6. The projector of claim 1, further comprising two or more lenses disposed proximate to the film array, the two or more lenses configured to reduce false aberrations.

7. The projector of claim 1, wherein the light array, reflector array, and film array are attached to a housing.

8. The projector of claim 7, wherein the housing further comprises a controller.

9. The projector of claim 8, wherein the controller comprises a memory storage for storing images, sequencing files, audio files, and/or software.

10. A projector for producing animation by flashing or blinking one or more light sources in a sequence, each light source associated with a specific image, the projector comprising:
a light array, comprising two or more light emitting diodes (LEDs), configured in a geometric pattern;
a reflector and condenser array, comprising a reflector cone for each LED, each reflector cone comprising an orifice or opening for receiving light from an LED, a reflective surface, and an output for shining the light from the LED, the reflector array configured in the geometric pattern to align the orifice or opening with each LED in the light array;
a film array, comprising a film portion aligned with each reflector cone in the reflector array, each film portion having an image printed, pasted, or saved thereon; and
two or more lenses disposed proximate to the film array, the two or more lenses configured to reduce false aberrations;
wherein the light array, reflector array, film array, and lenses are configured in a curved parabolic orientation.

11. The projector of claim 10, further comprising a control unit, including a memory storage for storing images, sequencing files, audio files, and/or software.
